(19) United States
(12) Patent Application Publication
(10) Pub. No.: US 2023/0177208 A1
(43) Pub. Date: Jun. 8, 2023

(54) Medical Provisioning System with Security Features

(71) Applicant: Hypatia Group, Inc., Reston, VA (US)

(72) Inventors: Kelly Marie McVearry, Washington, DC (US); Adam Rankin, Arlington, VA (US); Kenneth Kalunian, San Diego, CA (US)

(21) Appl. No.: 18/071,229

(22) Filed: Nov. 29, 2022

Related U.S. Application Data
(60) Provisional application No. 63/287,378, filed on Dec. 8, 2021.

(51) Int. Cl. G06F 21/62

(52) U.S. Cl. CPC G06F 21/6245

(57) ABSTRACT

A security system for shipped medical products or research tools includes a container with a least one closable opening. A closure mechanism positionable to seal the closable opening. The closure mechanism can have multiple touch zones, with each of the multiple touch zones providing a distinguishable electric signal. An electronic controller is attachable to the multiple touch zones of the closure mechanism and able to store and transmit a sequence of touches, with at least one sequence of touches indicating authorization for opening the container after removal of the closure mechanism.

### RELATED APPLICATION

The present disclosure is part of a non-provisional patent application claiming the priority benefit of U.S. Provisional Patent Application No. 63/287,378, filed on Dec. 8, 2021, which is hereby incorporated by reference in its entirety.

### FIELD OF THE INVENTION

This invention relates generally to the field of remote medical services, including providing trackable and secured medical materials for therapeutic or research purposes. In some embodiments, touch locks are incorporated into shippable containers.

### BACKGROUND

Remote medical services can use shipping containers for transport of medical materials or test kits to a patient. Ideally, such shipping containers would support various biometric or authorization procedures for identification, inspection, tracking, and tamper monitoring. Unfortunately, many conventional biometric methods, such as fingerprinting and temperature-based biometrics, can be too expensive or unreliable in patients with disabilities and disease characterized by microcirculation deficits in their fingers. This can include patients suffering from lupus, Raynaud's syndrome phenomenon, the elderly, or diabetics. Inexpensive shipping containers that improve medical supply chain monitoring through support of identification, inspection, tracking, and tamper monitoring of medical materials and that can be delivered by commercial mail or postal carriers are needed.

### BRIEF DESCRIPTION OF THE DRAWINGS

The specific features, aspects and advantages of the present invention will become better understood with regard to the following description and accompanying drawings where:

FIG. 1 illustrates a system supporting transport of shipping containers for medical materials;

FIG. 2A illustrates a shipping container with a tamper resistant security system;

FIG. 2B illustrates in more detail an example of a tamper resistant security system; and

FIG. 3 illustrates one embodiment of user interaction with a shipping container with a tamper resistant security system.

### DETAILED DESCRIPTION

In the following disclosure, reference is made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

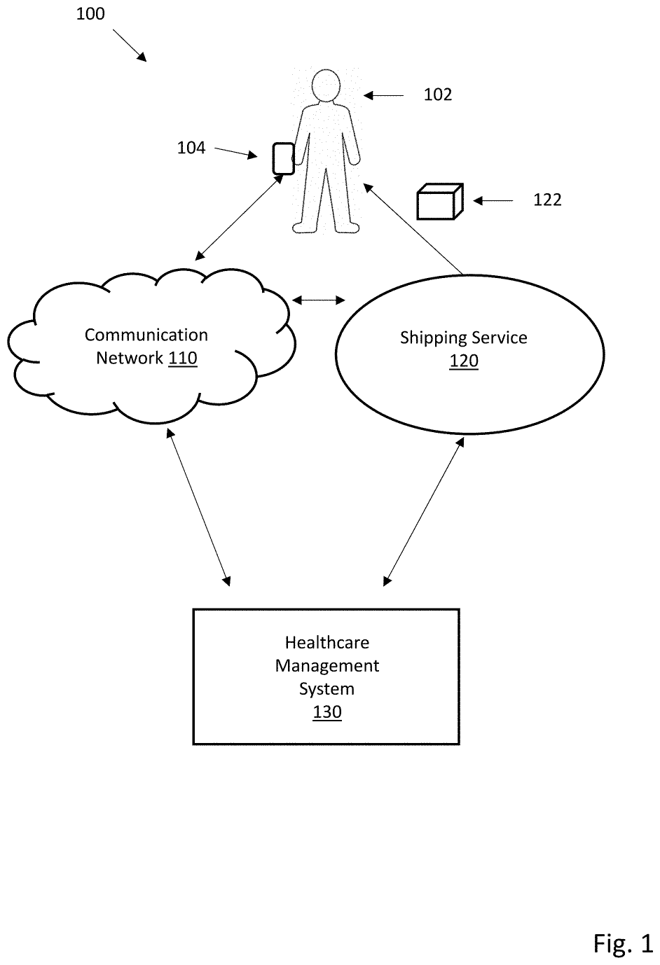

FIG. 1 is a block diagram depicting a system 100 within which an example embodiment may be implemented. A patient 102 with a device 104 can communicate via a communication network 110 with a shipping service 120 and a healthcare management system 130 to report arrival of a shipping container (e.g. box 122). In operation, system 100 can provide support for remote clinical trials and clinical care, with tracking of shipped clinical trial kits and medical supply kits. The system can improve patient safety, data quality and public health by increasing security of a supply chains of regulated products. Shipped regulated products can include clinical trial kits, medical supply kits, biological samples, pharmaceuticals, testing reagents, or other medical related products that can benefit from fully interoperable electronic track and trace systems. In one embodiment, the described shipped regulated products can be “regulated product sensors” under the Drug Supply Chain Security Act (DSCSA).

Patient 102 can be one or more individuals needing access to clinical trials or medical services, including longitudinal symptom tracking or other health monitoring services. In some embodiments patient 102 can be a selected or self-selected member of a group of patients that are members of a treatment group or pool. In other embodiments, patient 102 can provide medical data related to one symptom or condition, and later be selected to be a member of another a treatment group or pool.

Device 104 can be any of a wide variety of computing devices, such as a smart watch, a wearable device, smartphone, a desktop computer, a notebook computer, a tablet computer, a server computer, a handheld computer, imagers, digital cameras, and the like. The device 104 can include I/O device(s) include various devices that allow data and/or other information to be input to or retrieved. Example I/O device(s) include cursor control devices, keyboards, keypads, microphones, monitors or other display devices, speakers, printers, or network interface cards, modems, lenses, CCDs or other image capture devices, and the like. Device 104 can also include various interfaces that allow interaction with other systems, devices, or computing environments. For example, device 104 can include any number of different network interfaces, such as interfaces to local area networks (LANs), wide area networks (WANs), wireless networks, satellite networks, or other suitable internet or direct connection systems.

In some embodiments, device 104 includes one or more processors and processing support modules such as data busses, data oracles, smart contracts, memory device(s), mass storage device(s), decentralized ledger(s), and I/O device(s) to communicate with one other processing support modules, as well as other coupled devices. Busses can include one or more of several types of bus structures, such as a system bus, graphics bus, PCI bus, IEEE 1394 bus, or a USB bus. Using the processors and processing support modules, device 104 can execute programs or applications to provide for data capture, receipt, analysis, and transmission.

The device 104 can be connected to the communication network 110 but can also work independent of connection. Communication network 110 can include any type of network topology using any communication protocol. Additionally, data communication network 110 may include a combination of two or more communication networks. In some embodiments, data communication network 110 includes a cellular communication network, the Internet, a local area network, a wide area network, satellite networks, other suitable internet or direct connection systems, or any other communication network.

The healthcare management system 130 can be one or more systems that individually or collectively provide medical data collection and analysis services, along with support for remote clinical trials and clinical care. In some embodiments this can include tracking medical materials in storage in associated healthcare management system 130 facilities, or alternatively, in third party manufacturer or medical supply houses. This support can include tracking of shipped clinical trial kits and medical supply kits in conjunction with the shipping service 120 or other third party handlers of shipped or deliverable medical kits, supplies, or materials. Hardware supporting operation of the healthcare management system 120 can be similar to that discussed with respect device 104, but can further include use of interconnected computing devices, including one or more of server, desktop, or laptop computers. Interconnect can be through different network interfaces, such as interfaces to local area networks (LANs), wide area networks (WANs), wireless networks, the Internet, and blockchains.

In some embodiments, the healthcare management system 130 is operable on one or more processors and processing support modules such as data busses, memory device(s), mass storage device(s), and I/O device(s) to communicate with one other processing support modules, as well as other coupled devices. Busses can include one or more of several types of bus structures, such as a system bus, graphics bus, PCI bus, IEEE 1394 bus, or a USB bus. Using the processors and processing support modules, healthcare management system 130 can execute programs or applications to provide for data capture, receipt, analysis, and transmission.

The shipping service 120 can be one or more providers of material shipping, storage, and transportation. The shipping service 120 can track receipt of box 122 in response to direction or authorization by the healthcare management system 130, with position, securement, or environmental or physical conditions of box 122 monitored until deliver to patient 102. Upon delivery, successful opening of box 122 can be determined and notice of a positive or negative delivery result can be communicated via communication network 110 to the healthcare management system 130 and/or the shipping service 120. In some embodiments, the system 100 permits simple delivery of clinical trial kits and medical supply kits that support fully interoperable electronic track and trace systems.

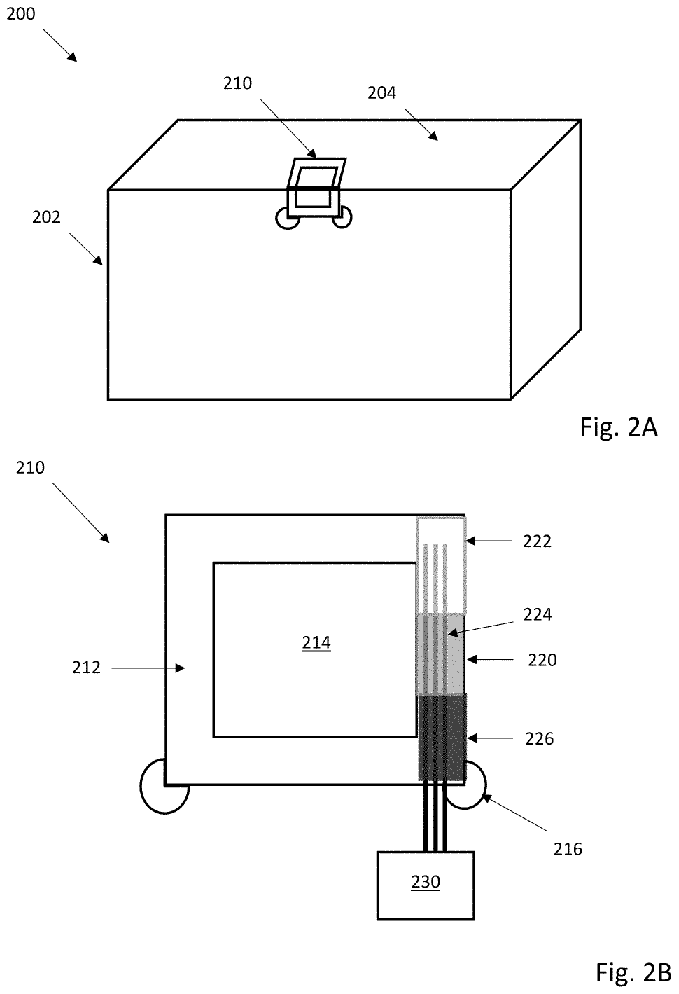

FIG. 2A illustrates in more detail elements a tamper resistant security system 200 suitable for use in conjunction with container 202 (or alternatively, box 122 or other suitable shipping container as discussed with respect to FIG. 1). In this embodiment, the container 202 has a hinge attached lid 204 that can be opened to allow access to items contained within the container 202. This opening into the container 202 can be sealed with a lock 210 that is able to provide a remote shipping or health management system with indication of tampering if the container is unsealed by an unauthorized recipient. In one embodiment, a low cost touch lock 210 can be used. An adhesive seal, mechanical interlock system, tie system, or other suitable locking system that supports sensors and electronic components can be used.

FIG. 2B illustrates in more detail components and operation of a touch lock 210. The touch lock 210 includes an adhesive patch with an outer edge 212 and an inner clear area 214. Non-adhesive pull tabs 216 are also attached. In operation, container 202 (FIG. 2A) is sealed with the touch lock, an openable by pulling upward on one or more pull tabs 216. The touch lock 210 also includes a soft potentiometer 220 that is divided into multiple zones 222, 224, and 226. Each zone can be color or pattern coded for distinguishment. The soft potentiometer 220 can be formed to have electrically conductive top and bottom layers, with difference in resistance when touched providing identification of linear position of a touch made into one of the multiple zones.

Control electronics 230 that measure resistance or other electrical properties (e.g. capacitance) can be attached to power and data lines that extend into the touch lock 210. The control electronics 230 can be positioned within or on the surface of the container 202, and can further include a battery, power capacitor, inductive charges, transponders, geospatial sensors, GPS/GNSS transponder or receivers, and temperature, vibration, shock, humidity, or other environmental sensors. In still other embodiments, active or passive RFID elements can be attached to the control electronics, or alternatively held within or attached to the container 202.

In operation, a patient or other user authorized to receive and open the container 202 can use a cell phone or other digital communication device or information from a separate physical mailing to input one or more touches into the touch lock 210. If the correct touch pattern is not input and the pull tabs engaged or touch lock 210 removed, a signal for unauthorized receipt and opening can be sent. In some embodiments, electronic devices within the container 202 can be disabled or rendered inoperative in response to the unauthorized signal. In other embodiments, a flag or other indicator can be used to indicate unauthorized equipment use. In still other embodiments, a message can be sent by an available communication system to indicate to the shipper or health management system that unauthorized use is occurring.

In one example, multiple zones 222, 224, and 226 respectively have yellow, blue, and purple colors. Touching a color (e.g. blue) communicates a different resistance score (ohms) as compared to touching purple or yellow. When a user touches a series of color, linear position, based on resistance score, is determined and the sequence provided to the control electronics 230. In one embodiment that acts as a physical instantiation of two-factor authentication, an authorized user on a software application can be asked to touch a series of colors that correspond to a sequence of touches on the soft potentiometer. The control electronics 230 can have a small memory that allows it to keep track of which colors have been touched in what order and can recognize when the authorized user has the box. A correct series of resistances (i.e. touching “blue, then red, then yellow”) sends “authorized” signal via the control electronics 230 and GPS/GNSS transponder. Incorrect series (i.e. touching yellow or just peeling away the adhesively attached touch lock 210) sends “unauthorized” signal via one or more of the user's cell phone or communication device, the control electronics 230, or GPS/GNSS transponder. This provides “near real” time tampering alert to the health management system, which can receive and communicate time, location and authorization data. Advantageously, in some embodiments medical supply chain data can be tracked on using a blockchain to further ensure the integrity of biological samples.

As will be understood, various other embodiments can replace or supplement, in whole or in part, color coded linear resistance measuring devices such a soft potentiometers. For example, capacitive or ultrasonic biometric (fingerprint) authentication can be used, as well as a Bluetooth/NFC authentication, a button keypad, a mechanical passcode lock, E-ink touch screen authentication, electronic adhesives, or other soft electronics (stickers, pull tabs, buttons). Light sensors can be used for notifications. Other embodiments can include use of GPS/GNSS location based authentication, QR code, RFID, or voice based authentication

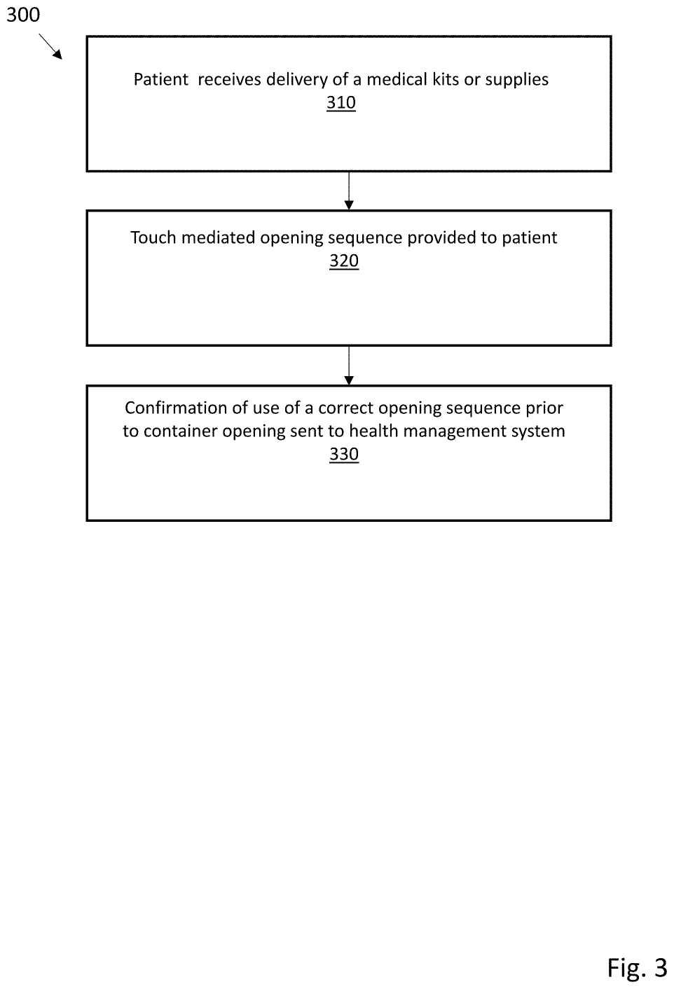

FIG. 3 illustrates one embodiment of a method 300 for use of a tamper resistant security system. In a first step 310, a patient receives delivery of a medical kits or supplies. In a second step 320, a touch mediated opening sequence is provided to the patient by a separate mailing or via an electronic communication device such as a smartphone. In a third step 330, confirmation of use of correct opening sequence (or notice on use of an incorrect sequence) prior to container opening is sent to health management system.

For purposes of illustration, programs and other executable program components are shown herein as discrete blocks, although it is understood that such programs and components may reside at various times in different storage components of local, server based, or cloud computing based systems and are executed by processor(s). Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter is described in language specific to structural features and/or methodological acts, it is to be understood that the subject matter defined in the appended claims is not necessarily limited to the described features or acts described herein. Rather, the described features and acts are disclosed as example forms of implementing the claims.

Those skilled in the art will appreciate that the disclosure may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. In some embodiments, more advanced procedures for providing tracking and data management services can be used, including use of blockchain based procedures. For example, blockchain data oracles that connect off-chain data with on-chain data can be used. Such data oracles provide a mechanism for a provenance blockchain or smart contract to interact with external data that represent real world monitoring events across a medical supply chain.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed herein may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the disclosure are directed to computer program products comprising such logic (e.g., in the form of software) stored on any computer useable medium. Such software, when executed in one or more data processing devices, causes a device to operate as described herein.

While various embodiments of the present disclosure are described herein, it should be understood that they are presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the described exemplary embodiments. The description herein is presented for the purposes of illustration and description. It is not intended to be exhaustive or to limit the disclosure to the precise form disclosed. Many modifications and variations are possible in light of the disclosed teaching. Further, it should be noted that any or all of the alternate implementations discussed herein may be used in any combination desired to form additional hybrid implementations of the disclosure.

1. A security system for shipped medical products, comprising
a container with a least one closable opening;
a closure mechanism positionable to seal the closable opening, the closure mechanism having multiple touch zones, each of the multiple touch zones providing a distinguishable electric signal; and
an electronic controller attachable to the multiple touch zones of the closure mechanism and able to store and transmit a sequence of touches, with at least one sequence of touches indicating authorization for opening the container after removal of the closure mechanism.

2. The security system of claim 1, wherein the closure mechanism is adhesively attachable.

3. The security system of claim 1, wherein each of the multiple touch zones of closure mechanism have differing colors or visually distinguishable patterns.

4. The security system of claim 1, wherein each of the multiple touch zones has a range of different measurable resistance.

5. The security system of claim 1, wherein the multiple touch zones closure mechanism have a system that supports measurement of linear resistance .

6. The security system of claim 1, wherein the multiple touch zones closure mechanism have a soft potentiometer.

7. The security system of claim 1, wherein container opening authorization status is provided to a health management system using the electronic controller and associated communication devices.

8. A security system, comprising
a closure mechanism positionable to seal a closable opening of a container, the closure mechanism having multiple touch zones, each of the multiple touch zones providing a distinguishable electric signal; and
an electronic controller attachable to the multiple touch zones of the closure mechanism and able to store and transmit a sequence of touches, with at least one sequence of touches indicating authorization for opening the container after removal of the closure mechanism.

9. The security system of claim 8, wherein the closure mechanism is adhesively attachable.

10. The security system of claim 8, wherein each of the multiple touch zones of closure mechanism have differing colors or visually distinguishable patterns.

11. The security system of claim 8, wherein each of the multiple touch zones has a range of different measurable resistance.

12. The security system of claim 8, wherein the multiple touch zones closure mechanism have a system that supports measurement of linear resistance.

13. The security system of claim 8, wherein the multiple touch zones closure mechanism have a soft potentiometer.

14. The security system of claim 8, wherein container opening authorization status is provided to a health management system using the electronic controller and associated communication devices.
